(19) United States
(12) Patent Application Publication
(10) Pub. No.: US 2020/0079294 A1
(43) Pub. Date: Mar. 12, 2020

(54) Transport Frame for Mounting a Gang Box onto a Vehicle

(71) Applicant: Brent Robert Zobel, Wickenburg, AZ (US)

(72) Inventor: Brent Robert Zobel, Wickenburg, AZ (US)

(21) Appl. No.: 16/601,390

(22) Filed: Oct. 14, 2019

Related U.S. Application Data
(63) Continuation-in-part of application No. PCT/IB2018/052599, filed on Apr. 13, 2018.
(60) Provisional application No. 62/484,997, filed on Apr. 13, 2017.
(60) Provisional application No. 62/883,813, filed on Aug. 7, 2019.

(51) Int. Cl. B60R 9/06

(52) U.S. Cl. CPC B60R 9/065; B60R 2011/004

(57) ABSTRACT

A transport frame for mounting a gang box onto a vehicle has a box-receiving basket, an intermediary support frame, and a vehicle coupling mechanism. The box-receiving basket is a cradle that is positioned around a base of the gang box. The intermediary support frame is a rigid structure that transfers the weight of the gang box from the box-receiving basket into the vehicle coupling mechanism. The vehicle coupling mechanism then transfers the weight of the gang box into the vehicle's trailer hitch. The box-receiving basket has a perimeter frame and multiple support beams. The support beams are connected across the perimeter frame to form a cage that conforms to the shape of the gang box. The intermediary frame is connected in between the box-receiving basket and the vehicle coupling mechanism so that the box-receiving basket is retained in a desired orientation relative to the vehicle.

The current application is a continuation-in-part (CIP) application of the Patent Cooperation Treaty (PCT) application PCT/IB2018/052599 filed on Apr. 13, 2017. The PCT application PCT/IB2018/052599 claims a priority to the U.S. Provisional Patent application Ser. No. 62/484,997 filed on Apr. 13, 2017.

### FIELD OF THE INVENTION

The present invention relates generally to a transport frame. More specifically, the present invention is a transport frame for a gang box that allows the user to mount the gang box onto a vehicle's trailer hitch.

### BACKGROUND OF THE INVENTION

The Process of loading and unloading construction materials can be difficult and time consuming. Frequently, a foreman must transport heavy and expensive tools between multiple job sites. This can be a problem when the foreman has to collect and then repack the tools for each job site. This can result in loss of, or damage to, the tools. To overcome this problem, many foremen use gang boxes as a simple way to keep track of and transport tools. While gang boxes act as a consolidated repository for tools, they are often large and heavy. Thus, difficult to transport.

The present invention addresses the difficulty in transporting gang boxes by providing a transport frame that can be mounted onto any vehicle with a trailer hitch. This functionality enables the foreman to easily load and unload the gang box at worksites. Additionally, the present invention enables the foreman to transport the gang box without the use of a specialty vehicle, such as a truck. The present invention provides a lightweight transport frame that secures the gang box in a desired orientation during transport.

### BRIEF DESCRIPTION OF THE DRAWINGS

FIG. 1 is a perspective view of the present invention with the box-retaining brace disconnected from the perimeter frame.

FIG. 2 is a left-side view of the present invention.

FIG. 3 is a top view of the present invention.

FIG. 4 is a left-side view of the present invention with the box-retaining brace mounted onto the perimeter frame and the support tensioning member connected between the vehicle coupling mechanism and the box-retaining brace.

FIG. 5 is a perspective view of the present invention with the box-retaining brace mounted onto the perimeter frame and the support tensioning member connected between the vehicle coupling mechanism and the box-retaining brace.

FIG. 6 is a left-side view of the present invention with the ramp in a deployed configuration and the support tensioning member in the supporting configuration.

FIG. 7 is a left-side view of the present invention with the ramp in a deployed configuration and the support tensioning member in the hauling configuration.

FIG. 8 is a left-side view of the present invention with the plurality of ramp pullies mounted onto the box-retaining brace.

FIG. 9 is a left-side view of the present invention with the ramp in a collapsed configuration

FIG. 10 is a perspective view of the lifting brackets found in the present invention. In this figure, the lifting brackets are being used to attach a hoist to a gang box.

FIG. 11 is a perspective view showing the tether points between the tensioning members and the pair of lifting brackets used in the present invention.

FIG. 12 is another perspective view showing the tether points between the tensioning members and the pair of lifting brackets used in the present invention.

FIG. 13 is a left-side view of the present invention while attached to a gang box that is mounted within the box-receiving basket.

### DETAIL DESCRIPTIONS OF THE INVENTION

All illustrations of the drawings are for the purpose of describing selected versions of the present invention and are not intended to limit the scope of the present invention.

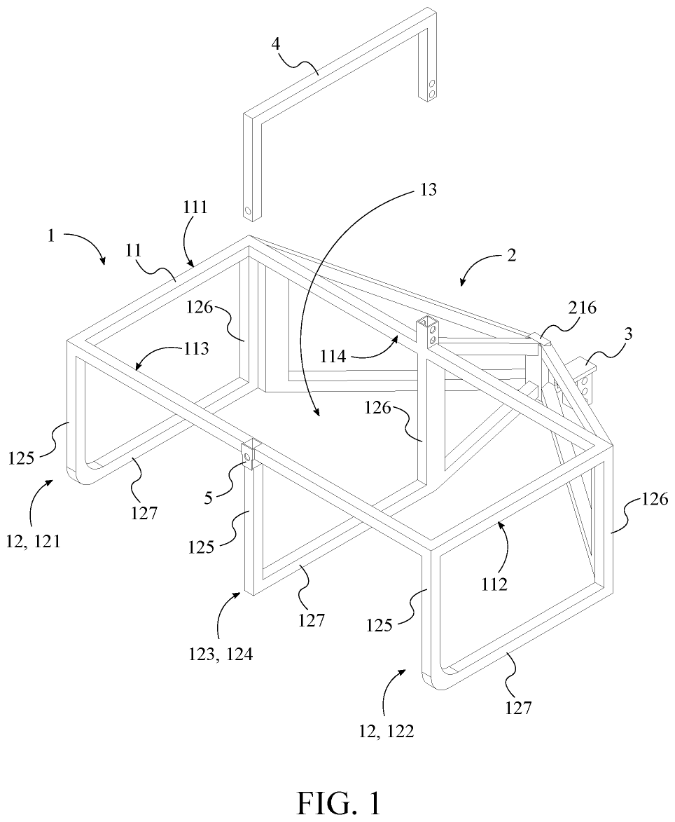

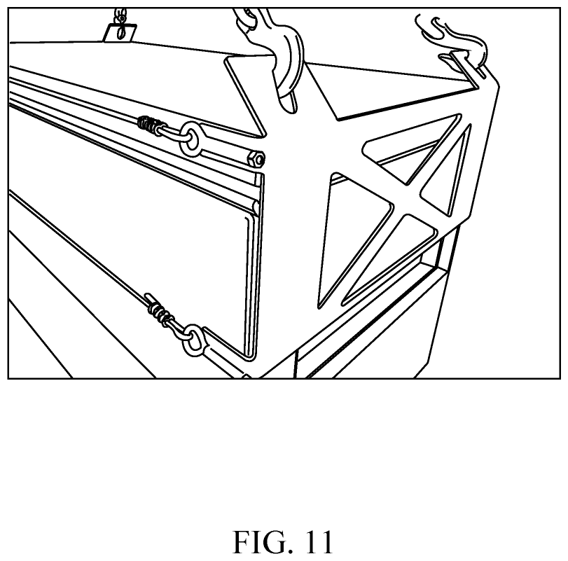

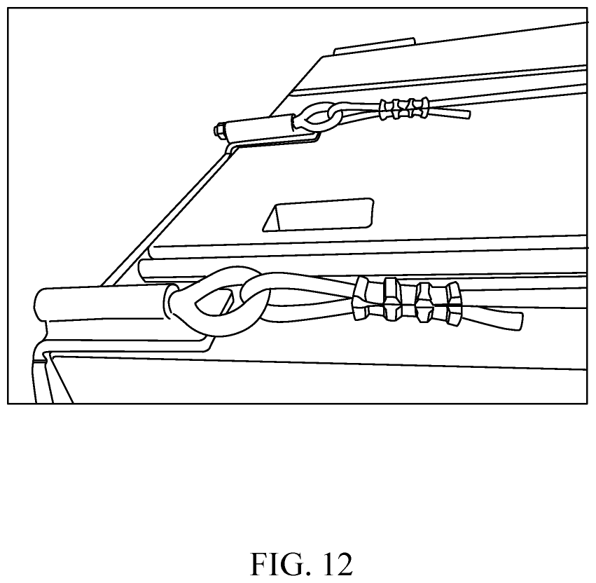

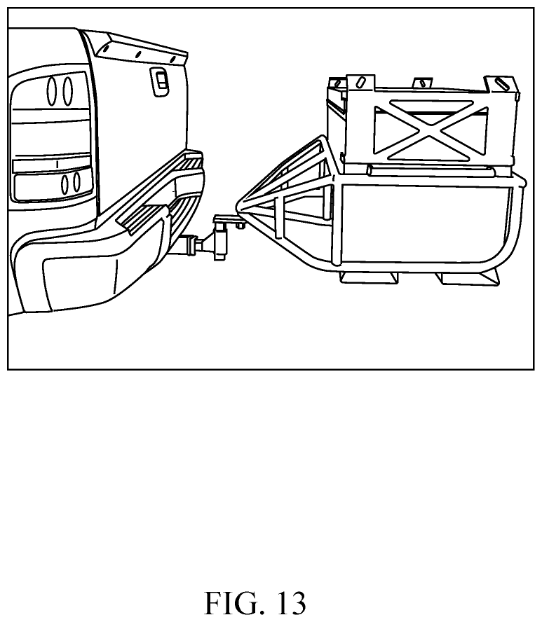

Referring to FIG. 1 through FIG. 13, the present invention, the transport frame for mounting a gang box onto a vehicle, is a carrying system that enables a user to mount a gang box onto a vehicle, for transport. To that end, the present invention is designed to be a transport frame that suspends the gang box off the ground and can be connected to a traditional trailer hitch. Further, the present invention is designed to distribute the weight of the gang box, such that the transport frame does not sag beneath the weight of a fully loaded gang box. Specifically, the present invention is able to accomplish this by comprising a box-receiving basket 1, an intermediary support frame 2, and a vehicle coupling mechanism 3. The box-receiving basket 1 is a cradle into which the gang box is inserted, for transport. To facilitate this functionality, the box-receiving basket 1 comprises a perimeter frame 11, a plurality of box-supporting beams 12, a first widthwise edge 111 and a second widthwise edge 112. The perimeter frame 11 is a rigid frame that is shaped to circumscribe the gang box. Additionally, the perimeter frame 11 forms an upper rim of the box-receiving basket 1. Further describing the geometry of the perimeter frame 11, the first widthwise edge 111 is positioned opposite to the second widthwise edge 112 across the perimeter frame 11. As a result, the perimeter frame 11 is formed into a rectangular shape that mirrors the dimensions of the gang box. While the perimeter frame 11 forms the upper rim of the box-receiving basket 1, the plurality of box-supporting beams 12 forms the body of the basket; delineating the shape of a box-receiving receptacle 13. Specifically, the plurality of box-supporting beams 12 is connected across the perimeter frame 11. Further, the plurality of box-supporting beams 12 is positioned in between the first widthwise edge 111 and the second widthwise edge 112. Thus positioned, the plurality of box-supporting beams 12 forms a cradle that wraps around the underside of the gang box. Additionally, the cradle formed by the plurality of box-receiving bars acts as the body of the box-receiving basket 1 that supports the weight of the gang box.

Referring to FIG. 1, the present invention is designed to support the weight of the gang box without being deformed. To facilitate this, the intermediary support frame 2 is a rigid structure that maintains the box-receiving basket 1 in an orientation designed to facilitate transporting the gang box. Specifically, the intermediary support frame 2 is adjacently mounted to the perimeter frame 11, opposite to the box-receiving receptacle 13 of the box-receiving basket 1. Accordingly, the intermediary support frame 2 is able to transfer the weight of the gang box from the box-receiving basket 1, to the vehicle coupling mechanism 3, and into the trailer hitch of the vehicle. The vehicle coupling mechanism 3 is a detachable fastener that forms a rigid connection with the vehicle. Preferably, the vehicle coupling mechanism 3 is a trailer hitch coupler. Additionally, the vehicle coupling mechanism 3 is adjacently connected to the intermediary support frame 2, opposite to the perimeter frame 11. Accordingly, the vehicle coupling mechanism 3 is able to form a detachable connection between the trailer hitch of the vehicle and the intermediary support frame 2.

Referring to FIG. 1, the box-receiving basket 1 is designed to be a lightweight carrying system that uses the plurality of box-supporting beams 12 to form a rigid cradle, which conforms to the shape of the gang box. That is, the plurality of box-supporting beams 12 forms a rigid cage that delineates the box-receiving receptacle 13 into which the gang box is inserted. To accomplish this, the plurality of box-supporting beams 12 comprises a first edge-support beam 121, a second edge-support beam 122, and at least one arbitrary support beam 123. Further, the plurality of box-supporting beams 12 is arranged into a series of bars, each of which is positioned to support a base of the gang box. Additionally, the first edge-support beam 121 is connected along the first widthwise edge 111. Similarly, the second edge-support beam 122 is connected along the second widthwise edge 112. As a result, the first edge-support beam 121 and the second edge-support beam 122 form the terminal ends of the cage that delineates the box-receiving receptacle 13 into which the gang box is inserted. Further, the first edge-support beam 121 and the second edge-support beam 122 support opposite ends of the gang box. The at least one arbitrary support beam 123 is positioned in between the first edge-support beam 121 and the second edge-support beam 122. As a result, the at least one arbitrary support beam 123 supports the body of the gang box that is positioned between the first edge-support beam 121 and the second edge-support beam 122.

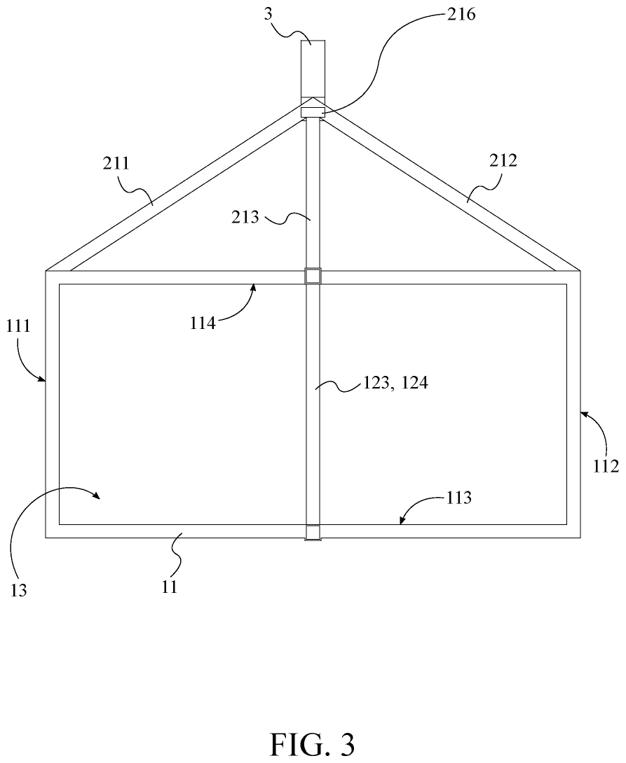

Referring to FIG. 1 and FIG. 3, as described above, the plurality of box-supporting beams 12 forms a rigid cradle that conforms to the shape of the gang box. To accomplish this, each of the plurality of box-supporting beams 12 comprises a first leg 125, a second leg 126, and a third leg 127. The three legs of each box-supporting beam 12 form a U-shaped member that delineates a base and sides of the box-receiving receptacle 13. Further, the perimeter frame 11 comprises a first lengthwise edge 113 and a second lengthwise edge 114. As such, the first lengthwise edge 113 is positioned opposite to the second lengthwise edge 114, across the perimeter frame 11. Additionally, the first lengthwise edge 113 and the second lengthwise edge 114 are positioned in between the first widthwise edge 111 and the second widthwise edge 112. Thus positioned, the first widthwise edge 111, the second widthwise edge 112, the first lengthwise edge 113, and the second lengthwise edge 114 define the rectangular shape of the perimeter frame 11. Expounding on the descriptions of each box-supporting beam, the first leg 125 is adjacently connected to the first lengthwise edge 113. The second leg 126 is connected adjacent to the second lengthwise edge 114. The third leg 127 is terminally connected to the first leg 125, opposite to the first lengthwise edge 113. Finally, the third leg 127 is terminally connected to the second leg 126, opposite to the second lengthwise edge 114. Thus positioned, the first leg 125, the second leg 126, and the third leg 127 form the bars of the cage that support the weight of the gang box while inserted into the box-receiving receptacle 13. Additionally, the plurality of box-supporting beams 12 forms a rectangular channel that supports the base of the gang box. It should be noted that present invention can be manufactured in various shapes and sizes without departing from the scope and spirit of the transport frame described herein. For example, a first alternative embodiment may use a circular perimeter frame 11. In this embodiment, the plurality of box-supporting beams 12 will remain connected across the perimeter frame 11. Thus, delineating the box-receiving receptacle 13.

Referring to FIG. 1 and FIG. 3, the present invention employs the intermediary support frame 2 to distribute the weight of the gang box, such that the gang box is prevented from moving while seated within the box-receiving receptacle 13. To achieve this, the intermediary support frame 2 comprises a plurality of support arms 21 and a nexus connector 216. The plurality of support arms 21 comprises rigid members that maintain the box-receiving basket 1 in a desired orientation, relative to the vehicle coupling mechanism 3. The nexus connector 216 is a rigid member that forms an anchor point for each of the plurality of support arms 21. Additionally, the nexus connector 216 is mounted onto the vehicle coupling mechanism 3. Consequently, the weight of the gang box it transferred through the intermediary support frame 2 and into the vehicle coupling mechanism 3. Additionally, each of the plurality of support arms 21 is terminally connected to the nexus connector 216. As a result, any external force that is applied to the plurality of support arms 21 will be transferred to the nexus connector 216. Relatedly, each of the plurality of support arms 21 is terminally connected to a corresponding support beam 124, opposite to the nexus connector 216. Further, the corresponding support beam 124 is from the plurality of box-supporting beams 12. As a result, each of the support arms 21 is used to transfer the load from the corresponding support beam 124, into the nexus connector 216. Preferably, the intermediary support frame 2 is a tapering structure that tapers from the second lengthwise edge 114 of the perimeter frame 11 to the nexus connector 216.

Referring to FIG. 1 and FIG. 3, as described above, the plurality of support arms 21 is designed to maintain the box-receiving basket 1 in a desired orientation while transferring the weight of the gang box into the vehicle coupling mechanism 3 and the attached trailer hitch. To that end, the plurality of support arms 21 comprises a first edge-support arm 211, a second edge-support arm 212, and at least one arbitrary support arm 213. Additionally, the plurality of support arms 21 is arranged into a tapering configuration that transfers the weight of the gang box to the nexus connector 216. Specifically, the first edge-support arm 211 is connected along the first widthwise edge 111. Similarly, the second edge-support arm 212 is connected along the second widthwise edge 112. As a result, the first edge-support arm 211 transfers the weight from the first edge-support beam 121 to the nexus connector 216. Likewise, the second edge-support arm 212 transfers the weight from the second edge-support beam 122 to the nexus connector 216. Further, the at least one arbitrary support arm 213 is positioned in between the first edge-support arm 211 and the second edge-support arm 212. As a result, the at least one arbitrary support arm 213 supports the corresponding support beam 124 that is positioned in between the first edge-support arm 211 and the second edge-support arm 212.

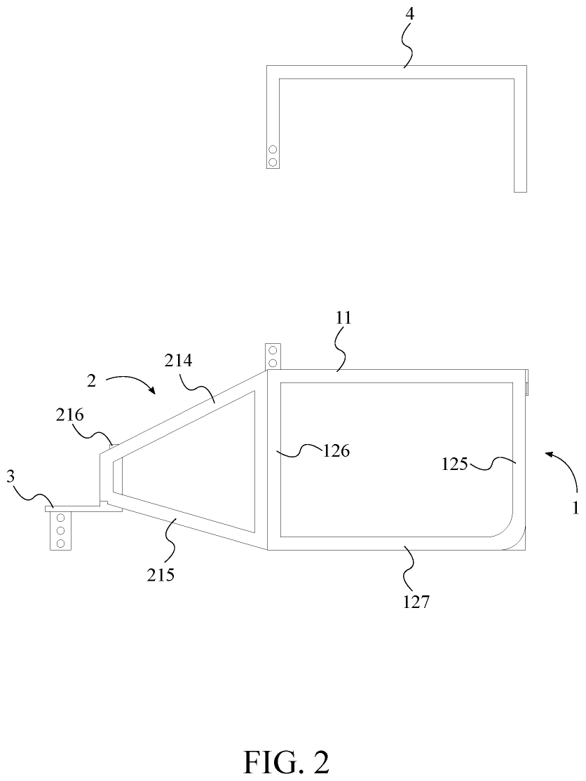

Referring to FIG. 1 and FIG. 2, the intermediary support frame 2 is designed to be a rigid and lightweight assembly. To accomplish this, each of the plurality of support arms 21 comprising a first bar 214 and a second bar 215. The first bar 214 is connected in between the nexus connector 216 and the corresponding support beam 124. Additionally, the first bar 214 is positioned adjacent to the perimeter frame 11. As a result, the first bar 214 acts as a connective brace that extends between an upper end of the box-receiving basket 1 and the nexus connector 216. Similarly, the second bar 215 is connected in between the nexus connector 216 and the corresponding support beam 124. Further, the second bar 215 is positioned offset from the first bar 214, across the corresponding support beam 124. Accordingly, the second bar 215 acts as a connective brace that extends between a lower end of the box-receiving basket 1 and the nexus connector 216. The positioning of the first bar 214 and the second bar 215 distributes the weight of the upper and lower portions of the box-receiving basket 1.

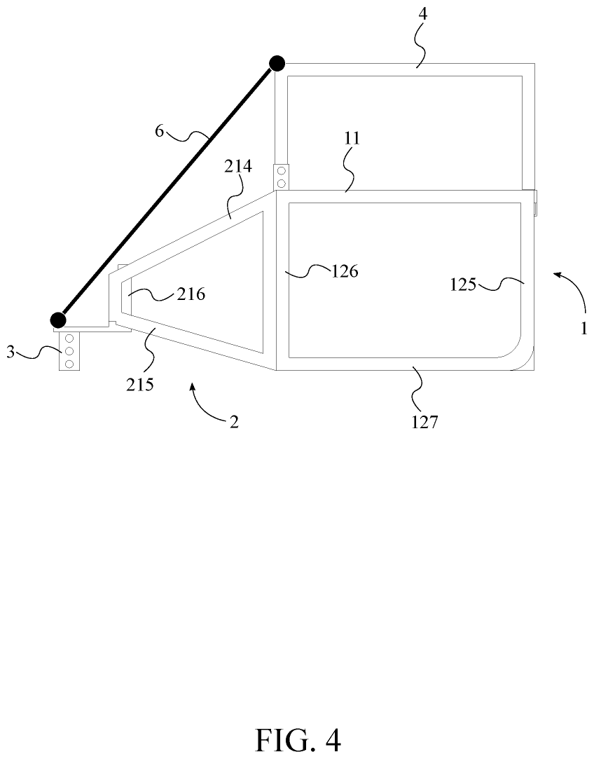

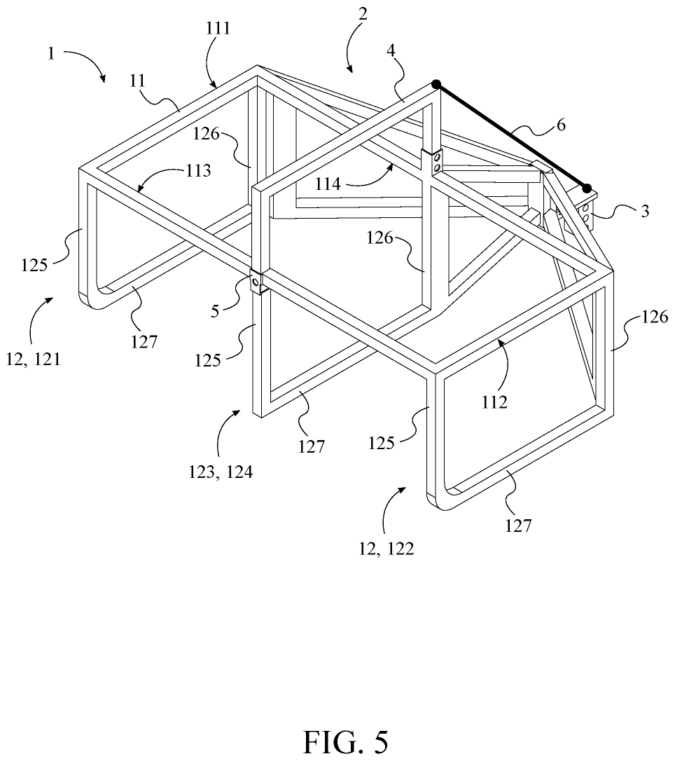

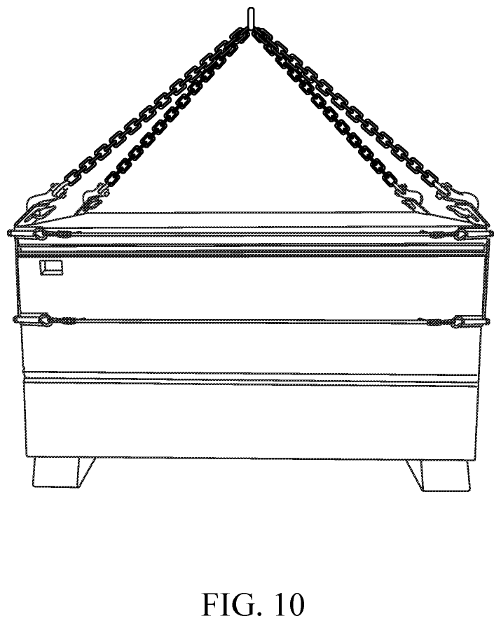

Referring to FIG. 1, FIG. 4, FIG. 5, and FIG. 10 through FIG. 13, the present invention can be used as part of a system for transporting a gang box between locations. This system comprises the transport frame for mounting a gang box onto a vehicle, and a bracket assembly for lifting a gang box. The bracket assembly is designed to be a reconfigurable harness that attaches to the gang box to form anchor points for a hoist. The method for implementing the system for transporting a gang box between locations is as follows. The user attaches the bracket assembly to the gang box. The user then attaches the bracket assembly to the hoist. Next, the user lifts the bracket assembly and the attached gang box using the hoist. The user then, lowers the gang box into the box-receiving receptacle 13. Finally, the user disconnects the bracket assembly from the gang box. These steps are repeated in reverse when extracting the gang box from the box-receiving receptacle 13.

Referring to FIG. 1, FIG. 4, FIG. 5, and FIG. 10 through FIG. 13, to implement this system, the bracket assembly makes use of a pair of brackets that function as anchor points for the hoist. Specifically, the bracket assembly comprises a first lifting bracket, a second lifting bracket, a first tensioning member and a second tensioning member. The first lifting bracket is laterally attached to the gang box. Similarly, the second lifting bracket is laterally attached to the gang box, opposite to the first lifting bracket. As a result, the first lifting bracket and the second lifting bracket are able to form anchor points that evenly distribute the weight of the gang box when the gang box is being lifted by the hoist. The first tensioning member and the second tensioning member are connected in between the first lifting bracket and the second lifting bracket. Accordingly, the first lifting bracket and the second lifting bracket can be tightened around the lateral sides of the gang box. This enables the user to securely affix the bracket assembly to the gang box prior to lifting the gang box. Both, the first lifting bracket and the second lifting bracket include support tabs that can be inserted into recesses in the gang box and serve to create a more robust connection be first lifting bracket and the second lifting bracket.

Referring to FIG. 1, FIG. 4, and FIG. 5, the present invention includes a securing member that prevents the gang box from being extracted from the box-receiving basket 1, while engaged. Specifically, the present invention comprises a box-retaining brace 4 and a locking mechanism 5. The box-retaining brace 4 is a rigid member that facilitates retaining the gang box in the box-receiving receptacle 13. To that end, the box-retaining brace 4 is mounted across the perimeter frame 11. Additionally, the perimeter frame 11 being positioned in between the box-retaining brace 4 and the plurality of box-supporting beams 12. As a result, the box-retaining brace 4 is able to clamp the gang box against the plurality of box-supporting beams 12 when mounted onto the perimeter frame 11. This functionality enables the user to prevent the gang box from becoming dislodged in the box-receiving receptacle 13. The locking mechanism 5 is integrated in between the box-retaining brace 4 and the perimeter frame 11 so that the user can secure the gang box against theft and unintentional release. Preferably, the locking mechanism 5 makes use of a pin-and-hole construction where inserting a pin through holes in the box-retaining brace 4 and the perimeter frame 11 locks the box-retaining brace 4 in place. The box-retaining brace 4 can be constructed using retention devices that include, but are not limited to, belts, webbing, bungies, and chains.

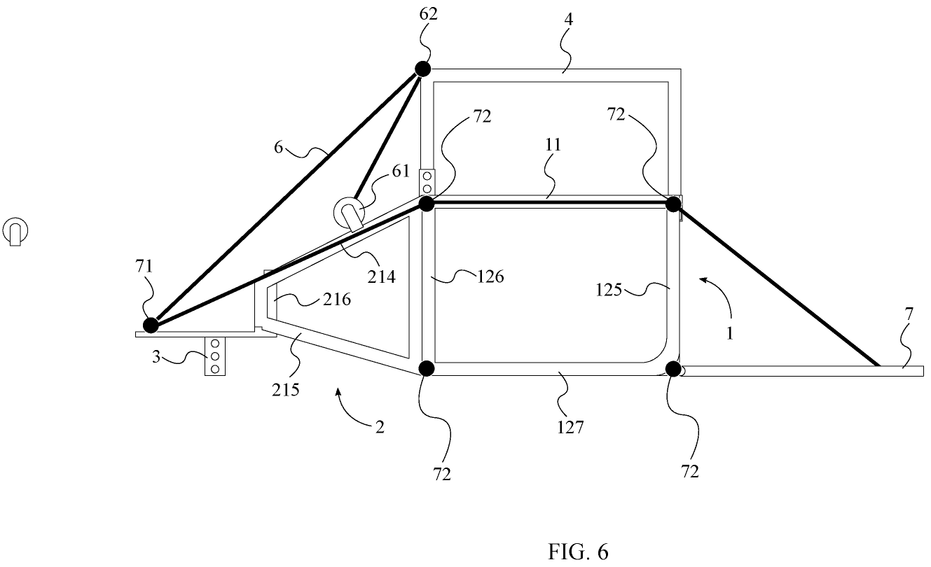

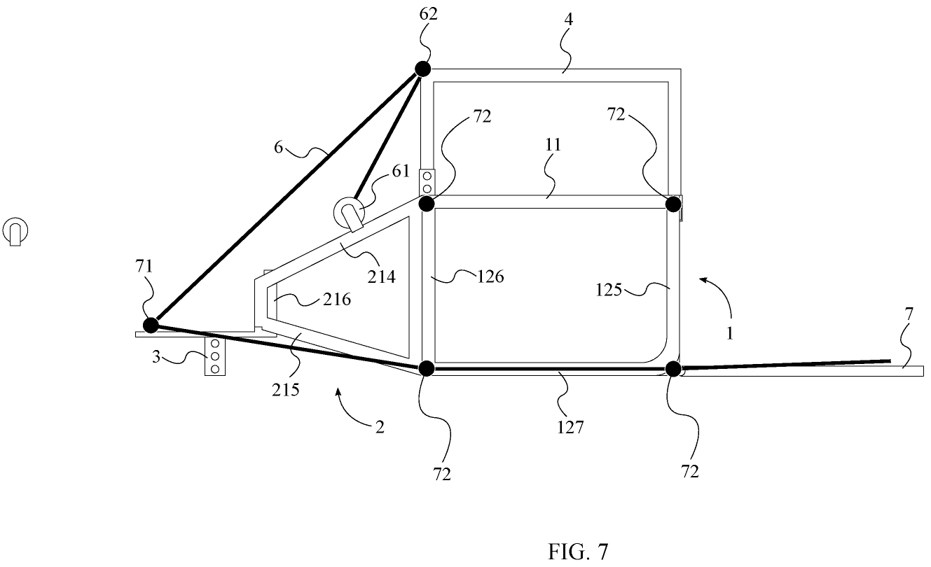

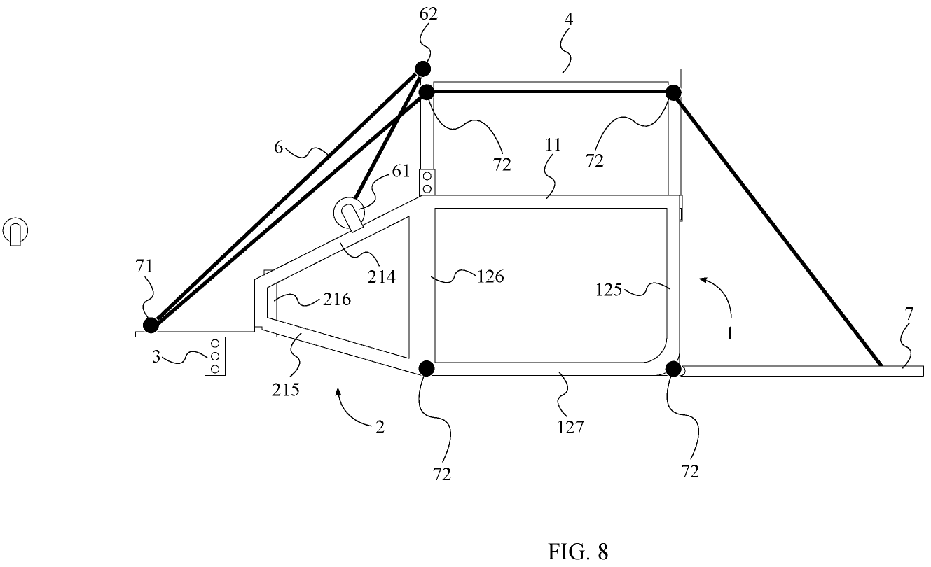

Referring to FIG. 7, FIG. 6, and FIG. 8, the present invention further comprises at least one support winch 61, at least one tensioning pulley 62, and at least one support tensioning member 6. The support winch 61 is mounted onto the intermediary support frame 2. Thus positioned, the support winch 61 is able to provide adequate counterforce to prevent the box-receiving basket 1 from collapsing or sagging beneath the weight of the gang box. The support tensioning member 6 is preferably a cable that provides additional structural support. The tensioning pulley 62 is mounted onto the box-retaining brace 4. Additionally, a fixed end of the support tensioning member 6 is terminally connected to the support winch 61. Accordingly, the support winch 61 is able to provide a counterforce that varies to accommodate different sized loads. Finally, the support tensioning member 6 is threaded through the tensioning pulley 62. Thus positioned, the tensioning pulley 62 enables the support winch 61 and support tensioning member 6 to utilize a mechanical advantage which reduces the work the support winch 61 is required to perform. Additionally, the tensioning pulley 62 acts as an anchor point for the support tensioning member 6, further stabilizing the box-receiving basket 1. In some embodiments, the support tensioning member 6 is a cable that is used to retain the box-retaining brace 4 in a desired orientation. In further embodiments, a free end of the support tensioning member 6 is tethered to the vehicle coupling mechanism. Thus connected, the support tensioning member 6 prevents the box-retaining brace 4 and the box-receiving basket 1 from sagging under the weight of the gang box. The support tensioning member 6 can be made using devices including, but not limited to, ratchet straps, bungies, winches, and belts. Additionally, multiple support tensioning members 6 can be used to further support the gang box.

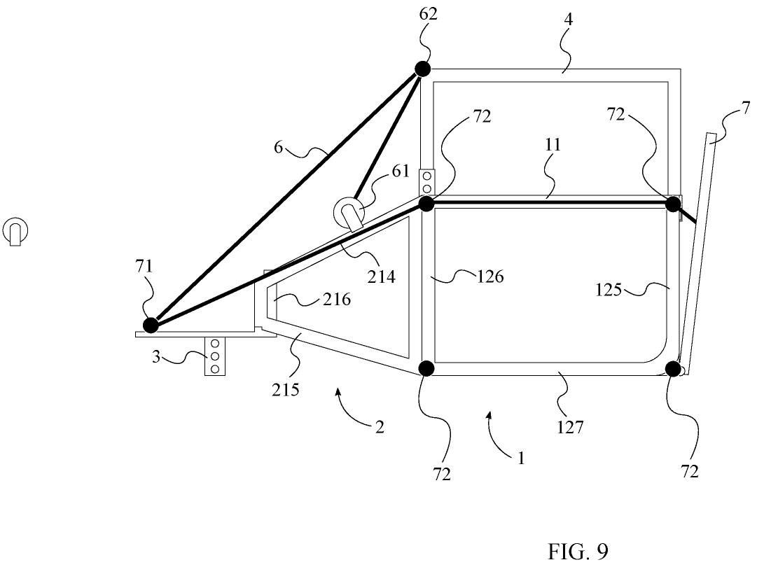

Referring to FIG. 6, through FIG. 9, the present invention is designed to facilitate loading and transporting the gang box. To that end, the present invention further comprises a loading ramp 7. The loading ramp 7 is a collapsible system that can be deployed or stowed, as required. To that tend, the loading ramp 7 is hingedly connected to the plurality of box-supporting beams 12. Accordingly, the loading ramp 7 is folded down to rest on the ground when in a deployed configuration. Likewise, the loading ramp 7 is folded up to rest against the perimeter frame 11 when in a collapsed configuration. The loading ramp 7 is positioned in between the first widthwise edge 111 and the second widthwise edge 112. Additionally, the loading ramp 7 is positioned offset from the perimeter frame 11 across the plurality of box-supporting beams 12. Thus positioned, the loading ramp 7 facilitates loading the present invention by enabling the user to roll the gang box up to the box-receiving basket 1.

Referring to FIG. 6, through FIG. 9, preferably, the loading ramp 7 is designed to reduce the work required to load the gang box into the box-receiving basket 1. To that end, the present invention further comprises at least one redirect pulley 71 and a plurality of utility pulleys 72. The redirect pulley 71 is mounted onto the vehicle coupling mechanism. Additionally, the plurality of utility pulleys is laterally mounted onto the box-receiving basket 1. further, the support tensioning member 6 is threaded through the plurality of utility pulleys 72 so that the support tensioning member 6 can be repositioned to operate the support ramp 7 or to haul the gang box up the support ramp 7. Specifically, the plurality of utility pulleys 72 enables the support tensioning member 6 to be transitioned between a supporting configuration and a hauling configuration. To achieve this functionality, the plurality of utility pullies 72 is subdivided into a plurality of ramp pulleys and a plurality of hauling pullies. The plurality of ramp pulleys is adjacently mounted to the perimeter frame 11 and positioned offset from the loading ramp 7, across the plurality of box-supporting beams 12. Thus positioned, the plurality of ramp pullies enables the smooth transfer of force from the support winch 61 to the loading ramp 7. The plurality of hauling pulleys is adjacently mounted to the plurality of box-supporting beams 12 and positioned offset from the perimeter frame 11, across the plurality of box-supporting beams 12. Thus positioned, the plurality of hauling pullies enables the support winch 61 to be used to haul various loads. The support tensioning member 6 is designed to be threaded through any number of the plurality of utility pulleys 72. Thus, the support tensioning member 6 is able to be positioned advantageously for a wide variety of tasks.

In the supporting configuration, the support tensioning member 6 is threaded through the plurality of ramp pulleys and the free end of the support tensioning member 6 is tethered to the loading ramp 7. Further, the tethered connection between the support tensioning member 6 and the loading ramp 7 is positioned offset from the plurality of box-supporting beams 12, across the loading ramp 7. As a result, the support winch 61 is able to transition the loading ramp 7 between the deployed configuration and the collapsed configuration by paying out or reeling in lengths of the ramp cable 73. In some embodiments, the plurality of ramp pulleys is distributed along the box-retaining brace 4. Thus positioned, the plurality of ramp pulleys enables the support tensioning member 6 to travel along the most optimal path between the support winch 61 and the loading ramp 7.

In the hauling configuration, the free end of the support tensioning cable 6 is tethered to the gang box, and then have the support winch 61. Thus, the support winch 61 is able haul the gang box up the loading ramp 7. Preferably a fastener or connector bracket is attached to the free end of the support tensioning member 6 so that the support tension member 6 can be quickly latched onto the gang box. In further embodiments, a human interface device is electronically coupled to the support winch 61. In this embodiment, the user is able to electronically control the functions of the support winch 61 by interacting with the human interface device.

Although the invention has been explained in relation to its preferred embodiment, it is to be understood that many other possible modifications and variations can be made without departing from the spirit and scope of the invention as hereinafter claimed.

What is claimed is:

1. A transport frame for mounting a gang box onto a vehicle comprising:
a box-receiving basket;
an intermediary support frame;
a vehicle coupling mechanism;
the box-receiving basket comprising a perimeter frame, a plurality of box-supporting beams, a first widthwise edge and a second widthwise edge;
the first widthwise edge being positioned opposite to the second widthwise edge across the perimeter frame;
the plurality of box-supporting beams being connected across the perimeter frame;
the plurality of box-supporting beams being positioned in between the first widthwise edge and the second widthwise edge;
the intermediary support frame being adjacently mounted to the perimeter frame, opposite to a box-receiving receptacle of the box-receiving basket; and
the vehicle coupling mechanism being adjacently connected to the intermediary support frame, opposite to the perimeter frame.

2. The transport frame for mounting a gang box onto a vehicle as claimed in claim 1 comprising:
the plurality of box-supporting beams comprising a first edge-support beam, a second edge-support beam, and at least one arbitrary support beam;
the first edge-support beam being connected along the first widthwise edge;
the second edge-support beam being connected along the second widthwise edge; and
the at least one arbitrary support beam being positioned in between the first edge-support beam and the second edge-support beam.

3. The transport frame for mounting a gang box onto a vehicle as claimed in claim 1 comprising:
each of the plurality of box-supporting beams comprising a first leg, a second leg, and a third leg;
the perimeter frame comprising a first lengthwise edge and a second lengthwise edge;
the first lengthwise edge being positioned opposite to the second lengthwise edge, across the perimeter frame;
the first lengthwise edge and the second lengthwise edge being positioned in between the first widthwise edge and the second widthwise edge;
the first leg being adjacently connected to the first lengthwise edge;
the second leg being connected adjacent to the second lengthwise edge;
the third leg being terminally connected to the first leg, opposite to the first lengthwise edge; and
the third leg being terminally connected to the second leg, opposite to the second lengthwise edge.

4. The transport frame for mounting a gang box onto a vehicle as claimed in claim 1 comprising:
the intermediary support frame comprising a plurality of support arms and a nexus connector;
the nexus connector being mounted onto the vehicle coupling mechanism;
each of the plurality of support arms being terminally connected to the nexus connector; and
each of the plurality of support arms being terminally connected to a corresponding support beam, opposite to the nexus connector, wherein the corresponding support beam is from the plurality of box-supporting beams.

5. The transport frame for mounting a gang box onto a vehicle as claimed in claim 4 comprising:
the plurality of support arms comprising a first edge-support arm, a second edge-support arm, and at least one arbitrary support arm;
the first edge-support arm being adjacently connected to the first widthwise edge;
the second edge-support arm being adjacently connected to the second widthwise edge; and
the arbitrary support arm being positioned in between the first edge-support arm and the second edge-support arm.

6. The transport frame for mounting a gang box onto a vehicle as claimed in claim 4 comprising:
each of the plurality of support arms comprising first bar and a second bar;
the first bar being connected in between the nexus connector and the corresponding support beam;
the first bar being positioned adjacent to the perimeter frame;
the second bar being connected in between the nexus connector and the corresponding support beam; and
the second bar being positioned offset from the first bar, across the corresponding support beam.

7. The transport frame for mounting a gang box onto a vehicle as claimed in claim 4, wherein the vehicle coupling mechanism being a trailer hitch coupler.

8. The transport frame for mounting a gang box onto a vehicle as claimed in claim 1 comprising:
a box-retaining brace;
a locking mechanism;
the box-retaining brace being mounted across the perimeter frame;
the perimeter frame being positioned in between the box-retaining brace and the plurality of box-supporting beams; and
the locking mechanism being integrated in between the box-retaining brace and the perimeter frame.

9. The transport frame for mounting a gang box onto a vehicle as claimed in claim 8 comprising:
at least one support winch;
at least one tensioning pulley;
at least one support tensioning member;
the support winch being mounted onto the intermediary support frame;
the tensioning pulley being mounted onto the box-retaining brace;
a fixed end of the support tensioning member being tethered to the winch; and
the support tensioning member being threaded through the tensioning pulley.

10. The transport frame for mounting a gang box onto a vehicle as claimed in claim 1 comprising:
a loading ramp;
the loading ramp being hingedly connected to the plurality of box-supporting beams;
the loading ramp being oriented perpendicular to the first widthwise edge;
the loading ramp being positioned in between the first widthwise edge and the second widthwise edge; and
the loading ramp being positioned offset from the perimeter frame across the plurality of box-supporting beams.

11. The transport frame for mounting a gang box onto a vehicle as claimed in claim 10 comprising:
at least one support tensioning member;
at least one redirect pulley;
a plurality of utility pulleys;
the redirect pulley being mounted onto the vehicle coupling mechanism;
the plurality of utility pulleys being laterally mounted onto the box-receiving basket; and
a free end of the support tensioning member being tethered to the ramp;
the support tensioning member being threaded through the redirect pulley and the plurality of utility pulleys.

12. A transport frame for mounting a gang box onto a vehicle comprising:
a box-receiving basket;
an intermediary support frame;
a vehicle coupling mechanism;
the box-receiving basket comprising a perimeter frame, a plurality of box-supporting beams, a first widthwise edge and a second widthwise edge;
the intermediary support frame comprising a plurality of support arms and a nexus connector;
the first widthwise edge being positioned opposite to the second widthwise edge across the perimeter frame;
the plurality of box-supporting beams being connected across the perimeter frame;
the plurality of box-supporting beams being positioned in between the first widthwise edge and the second widthwise edge;
the intermediary support frame being adjacently mounted to the perimeter frame, opposite to a box-receiving receptacle of the box-receiving basket;
the vehicle coupling mechanism being adjacently connected to the intermediary support frame, opposite to the perimeter frame;
the nexus connector being mounted onto the vehicle coupling mechanism;
each of the plurality of support arms being terminally connected to the nexus connector; and
each of the plurality of support arms being terminally connected to a corresponding support beam, opposite to the nexus connector, wherein the corresponding support beam is from the plurality of box-supporting beams.

13. The transport frame for mounting a gang box onto a vehicle as claimed in claim 12 comprising:
the plurality of box-supporting beams comprising a first edge-support beam, a second edge-support beam, and at least one arbitrary support beam;
the first edge-support beam being connected along the first widthwise edge;
the second edge-support beam being connected along the second widthwise edge; and
the at least one arbitrary support beam being positioned in between the first edge-support beam and the second edge-support beam.

14. The transport frame for mounting a gang box onto a vehicle as claimed in claim 12 comprising:
each of the plurality of box-supporting beams comprising a first leg, a second leg, and a third leg;
the perimeter frame comprising a first lengthwise edge and a second lengthwise edge;
the first lengthwise edge being positioned opposite to the second lengthwise edge, across the perimeter frame;
the first lengthwise edge and the second lengthwise edge being positioned in between the first widthwise edge and the second widthwise edge;
the first leg being adjacently connected to the first lengthwise edge;
the second leg being connected adjacent to the second lengthwise edge;
the third leg being terminally connected to the first leg, opposite to the first lengthwise edge; and
the third leg being terminally connected to the second leg, opposite to the second lengthwise edge.

15. The transport frame for mounting a gang box onto a vehicle as claimed in claim 12 comprising:
the plurality of support arms comprising a first edge-support arm, a second edge-support arm, and at least one arbitrary support arm;
the first edge-support arm being adjacently connected to the first widthwise edge;
the second edge-support arm being adjacently connected to the second widthwise edge; and
the arbitrary support arm being positioned in between the first edge-support arm and the second edge-support arm.

16. The transport frame for mounting a gang box onto a vehicle as claimed in claim 12 comprising:
each of the plurality of support arms comprising first bar and a second bar;
the first bar being connected in between the nexus connector and the corresponding support beam;
the first bar being positioned adjacent to the perimeter frame;
the second bar being connected in between the nexus connector and the corresponding support beam; and
the second bar being positioned offset from the first bar, across the corresponding support beam.

17. The transport frame for mounting a gang box onto a vehicle as claimed in claim 12, wherein the vehicle coupling mechanism being a trailer hitch coupler.

18. The transport frame for mounting a gang box onto a vehicle as claimed in claim 12 comprising:
a box-retaining brace;
a locking mechanism;
the box-retaining brace being mounted across the perimeter frame;
the perimeter frame being positioned in between the box-retaining brace and the plurality of box-supporting beams; and
the locking mechanism being integrated in between the box-retaining brace and the perimeter frame.

19. The transport frame for mounting a gang box onto a vehicle as claimed in claim 18 comprising:
a support tensioning member; and
the support tensioning member being connected in between the box-retaining brace and the vehicle coupling mechanism.
